(19) United States
(12) Patent Application Publication
(10) Pub. No.: US 2005/0283719 A1
(43) Pub. Date: Dec. 22, 2005

(54) HTML file processing technique

(75) Inventors: Yasuhiko Awamoto, Shinagawa (JP); Hisao Sasaki, Shinagawa (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/968,118

(22) Filed: Oct. 20, 2004

(30) Foreign Application Priority Data
Jun. 17, 2004 (JP) 2004-179237

(51) Int. Cl. G06F 17/24

(52) U.S. Cl. 715/513

(57) ABSTRACT

In order to provide a technique of enabling any user to browse data of a table in a desired hierarchical structure, an HTML (Hyper Text Markup Language) file processing method comprises: if an HTML file containing a table definition is received from another server in response to a request from a terminal of a user, referring to a hierarchical display definition data storage for storing hierarchical display definition data of a table preset by the user for a specific HTML file containing a table definition, and specifying a hierarchical display definition data for the received HTML file; and by extracting display elements to be displayed at a first hierarchical layer of the received HTML file according to the specified hierarchical display definition data, generating and transmitting to the terminal of the user, an HTML file for the first hierarchical layer. Accordingly, the HTML file containing the table definition is reconstructed by using the hierarchical display definition data set by the user, and thus the user can efficiently browse desired data in the table.

### TECHNICAL FIELD OF THE INVENTION

The present invention relates to a relay processing technique between a Web site and a client terminal.

### BACKGROUND OF THE INVENTION

When a Web page containing a table which is provided on the assumption that it is displayed on a display screen of a personal computer is displayed on a cellular phone or PDA (Personal Digital Assistant) having a display screen smaller than the display screen of the personal computer, there is a problem in not only perspicuity, but also operability because the table runs off the edge of the display screen.

Thereupon, for example, EP-0949571-A discloses such a technique that a Web document which is designed so as to be displayed on a display screen of a desk top computer is displayed on a smaller display of PDA, a cellular phone or the like. According to this technique, a Web document obtained from a distributed network is analyzed to generate an abstract syntax tree, and various modifications are applied to the elements of the document to divide the Web document into smaller subpages, which can be displayed on a display device having a limited display area so that each subpage is legible and can be navigated. Moreover, this technique has a document filtering subsystem, and a user can select information to be displayed on the display device having the limited display area. However, it is not designed so that the user can define the hierarchical structure of the Web page when the table is divisionally displayed.

According to the above technique, if truly necessary data are located at a lower hierarchical layer of the Web page when the table is divisionally displayed, much labor and much time are needed to browse the data concerned.

### SUMMARY OF THE INVENTION

Therefore, an object of the present invention is to provide a technique of enabling any user to browse data of a table in a desired hierarchical structure.

In order to attain the above object, an HTML (Hyper Text Markup Language) file processing method according to the present invention comprises: if an HTML file containing a table definition is received from another server in response to a request from a terminal of a user, referring to a hierarchical display definition data storage for storing hierarchical display definition data of a table preset by the user for a specific HTML file containing a table definition, and specifying a hierarchical display definition data for the received HTML file; and by extracting display elements to be displayed at a first hierarchical layer of the received HTML file according to the specified hierarchical display definition data, generating and transmitting to the terminal of the user, an HTML file for the first hierarchical layer.

Accordingly, the HTML file containing the table definition is reconstructed by using the hierarchical display definition data set by the user, and thus the user can efficiently browse desired data in the table.

Incidentally, the aforementioned HTML file for the first hierarchical layer may contain data for enabling an instruction of generating (including reconstructing) the hierarchical display definition data for the received HTML file. That is, it becomes possible for the user to instruct the generation of the hierarchical display definition data corresponding to the HTML file relating to a Web page, which is firstly browsed, or the hierarchical display definition data corresponding to the HTML file relating to a Web page, which is browsed again, by instructing only browsing of the Web page. Therefore, the convenience for the user is enhanced.

Furthermore, the aforementioned HTML file for the first hierarchical layer may include data for enabling selection of any one of display elements to be displayed at the first hierarchical layer. In the case of the table, even when data of only one or plural columns are displayed, it is difficult to say that the data is easily viewable for users. For example, because it is not rare to pay attention only to a specific line, a line to which attention should be paid is specified at the first hierarchical layer, and the data of the line concerned is displayed at a lower hierarchical layer.

Furthermore, the HTML file processing method of the present invention may further comprise: if an instruction of generating hierarchical display definition data is received from the terminal of the user, generating and transmitting to the terminal of the user, an HTML file containing headings contained in the aforementioned table and data for enabling to designate a display hierarchical layer for each of the headings, by referring to the received HTML file; and if designation data of the display hierarchical layer of the heading is received from the terminal of the user, generating and storing into the hierarchical display definition data storage, hierarchical display definition data from the designation data. Accordingly, the user can easily define a way for hierarchical display of the table.

A program for making a computer execute the HTML file processing method of the present invention can be created, and the program is stored in a storage medium or a storage device, such as a flexile disk, CD-ROM, an magneto-optical disk, a semiconductor memory, a hard disk or the like. Moreover, the program may be distributed as digital signals through a network or the like. An intermediate processing result is temporarily stored in a storage device such as a main memory or the like.

### BRIEF DESCRIPTION OF THE DRAWINGS

FIG. 1 is a diagram showing a system according to one embodiment of the present invention;

FIG. 2 is a diagram showing a first processing flow of the embodiment of the present invention;

FIG. 3 is a diagram showing a second processing flow of the embodiment of the present invention;

FIG. 4 is a diagram showing an example of table definition;

FIG. 5 is a diagram showing an example of an HTML file;

FIG. 6 is a diagram showing an example of displaying a table on a large-sized display screen;

FIGS. 7A to 7D are diagrams showing examples of a divisional table page and examples of a definition input page;

FIG. 8 is a diagram showing a third processing flow of the embodiment of the present invention;

FIG. 9 is a diagram showing a fourth processing flow of the embodiment of the present invention; and

FIG. 10 is a functional diagram of a normal computer.

### DETAILED DESCRIPTION OF THE PREFERRED EMBODIMENTS

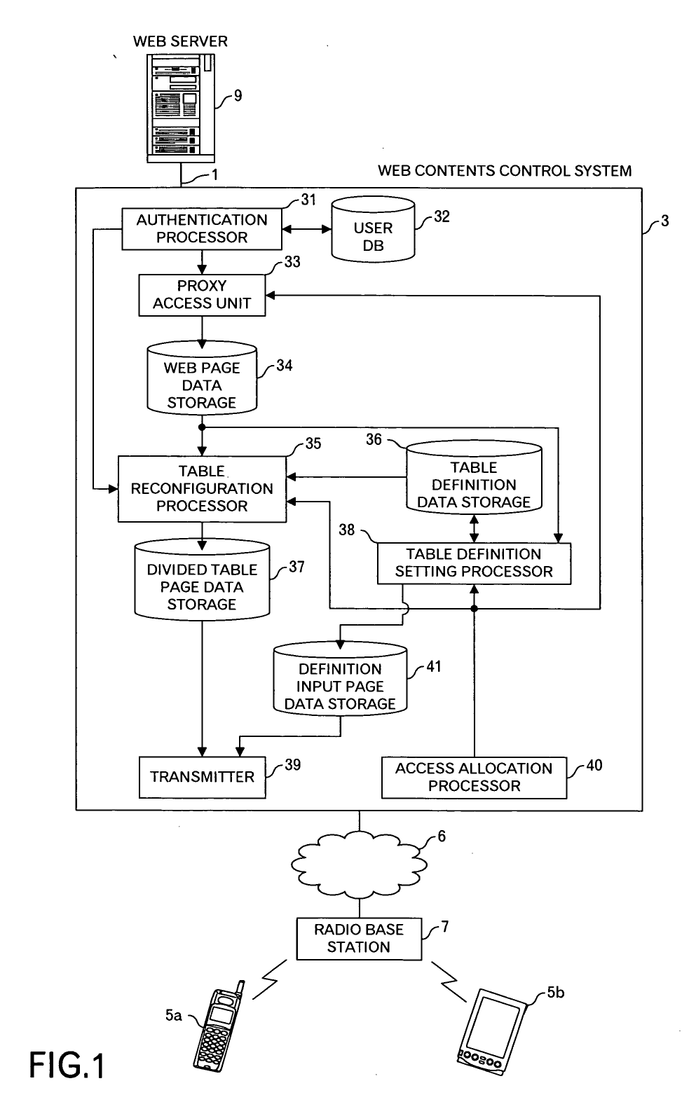

FIG. 1 shows a diagram showing a system according to one embodiment of the present invention. For example, one or plural Web serves 9 and a Web contents control system 3 for executing the main processing in this embodiment are connected to a network 1 such as the Internet, LAN (Local Area Network) or the like. The Web contents control system 3 is connected to a radio base station 7 through a network 6 such as the Internet or the like. A cellular phone 5a or PDA 5b, which has a Web browser, is wirelessly connected to the radio base station 7. The numbers of cellular phones, PDAs and radio base stations are not limited to specific values, and they are not main portions of the present invention. Therefore, they are singly illustrated in FIG. 1. Moreover, the networks 1 and 6 may be any type of networks.

The Web contents control system 3 is set up between the Web server 9 and the cellular hone 5a or PDA 5b, is a system for relaying Web page data and is composed of one or plural servers. The Web contents control system 3 comprises: a user DB 32 for storing IDs and passwords of the users and the like; an authentication processor 31 for carrying out authentication processing for users by referring to the user DB 32 and outputting the user ID of an access source user to a table reconfiguration processor 35; an proxy access unit 33 for accessing the Web server 9 or the like on behalf of the cellular phone 5a or the like and storing obtained Web page data into a Web page data storage 34; the Web page data storage 34 for storing Web page data (containing an HTML file) obtained by the proxy access unit 33; a table definition data storage 36 for storing table definition, which is data representing a hierarchical structure when a table in a Web page is divisionally displayed; the table reconfiguration processor 35 for referring to the table definition data storage 36 to specify table definition to be applied, generating divided table page data from the Web page data stored in the Web page data storage 34 according to the table definition concerned, and storing the divided table page data thus generated into a divided table page data storage 37; the divided table page data storage 37 for storing the divided table page data, an access allocation processor 40 for carrying out the processing of allocating accesses from the cellular phone 5a or the like to the proxy access unit 33, a table definition setting processor 38 and the table reconfiguration processor 35; the table definition setting processor 38 for referring to the table definition data storage 36 and the Web page data storage 34 to generate definition input page data to prompt a user to input data used as an origin for the table definition, storing the generated definition input page data into a definition input page data storage 41, generating table definition on the basis of a response from the user, and storing the generated table definition into the table definition data storage 36; the definition input page data storage 41 for storing the definition input page data; and a transmitter 39 for transmitting the page data stored in the definition input page data storage 41 or the divided table page data storage 37 to the cellular phone 5a or the like. Incidentally, it is assumed that the corresponding relationship between received URL (Uniform Resource Locator) and URL of a transfer destination Web server has been registered in the Web contents control system 3 in advance. In addition, after authentication processing is once completed by the authentication processor 31, the session between the user terminal such as the cellular phone 5a or the like and the Web contents control system 3 is assumed to be maintained and managed by a cookie or a session ID in URL during an appropriate period. The maintenance and management of the session are well known, and thus the description thereof is omitted. In this embodiment, it is assumed that an HTML file (i.e. URL) and user ID can be specified from a session ID.

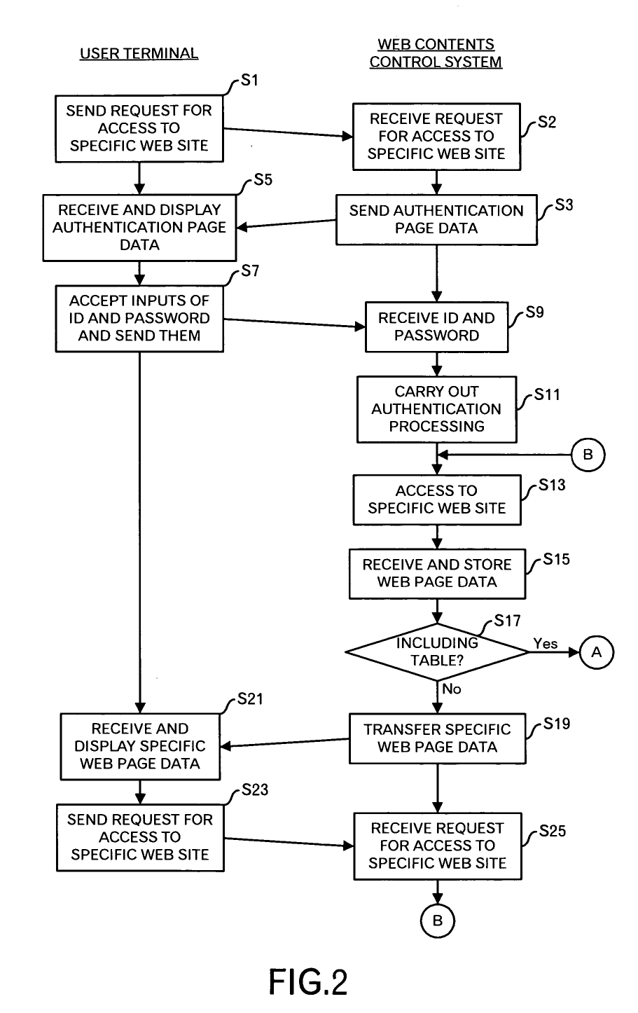

Next, the processing flow of the system shown in FIG. 1 will be described with reference to FIGS. 2 to 8. First, in response to an instruction of a user, a user terminal (cellular phone 5a or PDA 5b, the same is applied to the following description) transmits a request for an access to a specific Web site to the Web contents control system 3 (step S1). When the authentication processor 31 of the Web contents control system 3 receives an access from a user terminal for which the session management is not carried out (when it receives a request for an access to a specific Web site) (step S2), it temporarily stores the request into a storage device such as a main memory or the like, and transmits authentication page data to the user terminal (step S3). The user terminal receives the authentication page data from the Web contents control system 3, and displays it on the display device (step S5). The user inputs his or her user ID and password into the authentication page. The user terminal accepts the input of the user ID and the password, and transmits them to the Web contents control system 3 (step S7). The authentication processor 31 of the Web contents control system 3 receives the user ID and the password from the user terminal (step S9) , and refers to the user DB 32 to carry out the authentication processing (step S11). Because the user ID and the password are registered in the user DB 32, and it searches the user DB 32 on the basis of the received user ID to extract the corresponding password, and compares the extracted password with the received password. If it is judged that both the passwords are not coincident with each other or the password cannot be extracted from the user DB 32, the authentication fails and thus the processing returns to the step S3.

In a case where it is judged that the passwords are coincident with each other, that is, authentication succeeds, a processing request for the received access request is output from the authentication processing unit 31 to the proxy access unit 33 of the Web contents control system 3, and the proxy access unit 33 accesses a specific Web site on behalf of the user terminal (step S13). That is, the access request to the specific Web site, which was received in the step S2, is transmitted to the specific Web site (in this case, the Web server 9). In response to the access request, the Web server 9 returns specific Web page data (in this case, HTML file, the same is applied to the following description). The proxy access unit 33 of the Web contents control system 3 receives the specific Web page data and stores the data into the Web page data storage 34 (step S15).

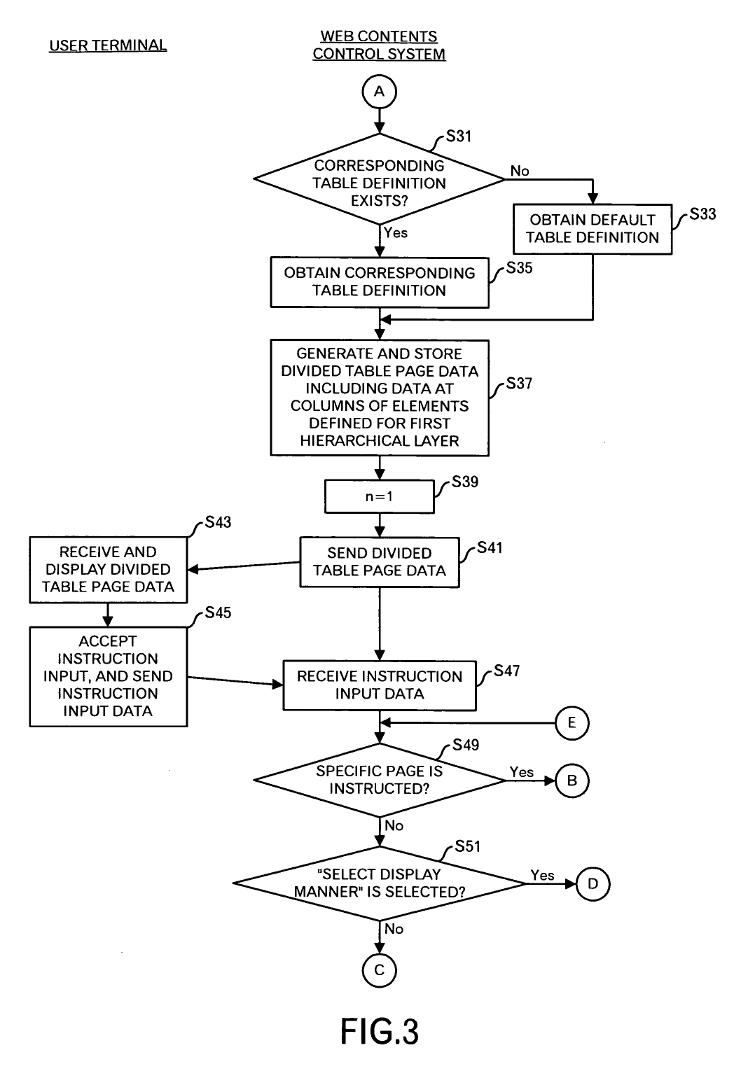

The table reconfiguration processor 35 analyzes the Web page data stored in the Web page data storage 34, and judges whether the page contains a table or not (step S17). If the table is contained, a <table> tag is contained in the HTML file, and thus the judgment is made on the basis of the presence or absence of the <table> tag. If a <table> tag is contained in the HTML file, the processing shifts to the processing of FIG. 3 through a terminal A.

On the other hand, if no <table> tag is contained in the HTML file, the table reconfiguration processor 35 stores into the divided table page data storage 37, the specific Web page data itself, which was stored in the Web page data storage 34. The transmitter 39 transmits the specific Web page data to the user terminal (step S19). The user terminal receives the specific Web page data from the Web contents control system 3, and displays the data on the display device (step S21). The subsequent processing is the same as the prior art, and when the user terminal transmits a request for the access to the specific Web site to the Web contents control system 3 (step S23), the access allocation processor 40 receives the access request (step S25), and judges that the access is a normal access, and thus requests the proxy access unit 33 to carry out the processing with respect to the access request. That is, the processing is shifted from a terminal B to the step S13.

Next, the processing subsequent to the terminal A will be described with reference to FIG. 3. The table reconfiguration processor 35 refers to the table definition data storage 36 to judge whether the table definition corresponding to the received Web page data (HTML file) is stored or not (step S31). At this time, by using user ID specified by the authentication processor 31, it specifies the file of the table definition corresponding to the specified user ID in the table definition data storage 36, and checks whether the table definition corresponding to the received HTML file is contained in the file of the table definition of the user concerned. If it is judged that the corresponding table definition is not stored in the table definition data storage 36 (containing a case where the file of the table definition corresponding to the user ID does not exist), it acquires default table definition from the table definition data storage 36 (step S33). On the other hand, if it is judged that the corresponding table definition is stored in the table definition data storage 36, it acquires the corresponding table definition from the table definition data storage 36 (step S35).

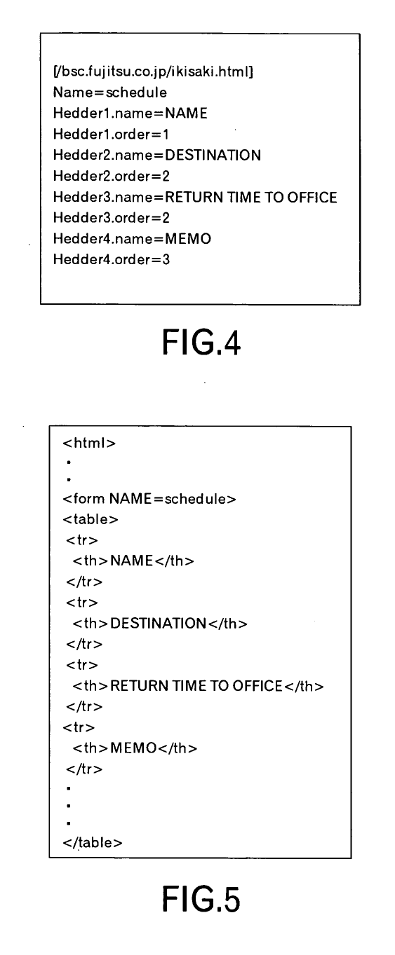

FIG. 4 shows an example of the table definition, and FIG. 5 shows an example of the corresponding HTML file (a part of the HTML file). In this embodiment, one file for the table definition is provided every user. In the example of FIG. 4, the file contains a record for specifying a target HTML file (URL: [/bsc.fujitsu.co.jp/ikisaki.html]), a target table name (Name=schedule), data for specifying a first heading of the table (Hedder1.name=name) and data for specifying the hierarchical layer number thereof (Hedder1.order=1), data for specifying a second heading of the table (Hedder2.name=destination) and data for specifying the hierarchical number thereof (Hedder2.order=2), data for specifying a third heading of the table (Hedder3.name=return time to office) and data for specifying the hierarchical number thereof (Hedder3.order=2), and data for specifying a fourth heading of the table (Hedder4.name =memo) and data for specifying the hierarchical number thereof (Hedder4.order=3).

FIG. 5 shows the contents of [/bsc.fujitsu.co.jp/ikisaki.html]. A <form> tag is a tag for defining a table, and it defines the table name with an attribute name. Here, the table name is “schedule”. Moreover, a heading name of the table is provided between a <th> tag and a </th> tag.

Accordingly, as shown in FIG. 4, the target table name “schedule” and the heading names of the table “name”, “destination”, “return time to office”, “memo” are contained in the table definition. According to the table definition of FIG. 4, “name” is set to the first hierarchical layer, “destination” and “return time to office” are set to the second hierarchical layer, and “memo” is set to the third hierarchical layer.

With respect to the table definition set by a specific user, all the table definitions are stored in one file in the form as shown in FIG. 4. On the other hand, the default table definition is applied to all the HTML files containing tables, and for example, it contains data for instructing to successively construct hierarchical layers from the left side of the heading names contained in the table. Accordingly, with respect to the table of the HTML file as shown in FIG. 5, the hierarchical structure is specified like “name” is set to the first hierarchical layer, “destination” is set to the second hierarchical layer, “return time to office” is set to the third hierarchical layer and “memo” is set to the fourth hierarchical layer.

Returning to the explanation of FIG. 3, the table reconfiguration processor 35 generates divided table page data containing data at columns of elements (heading columns) defined for the first hierarchical layer, according to the obtained table definition, and stores the generated data into the divided table page data storage 37 (step S37). The table reconfiguration processor 35 sets n, which is a counter, to 1 (step S39).

Thereafter, the transmitter 39 refers to the divided table page data storage 37 and transmits the divided table page data stored therein to the user terminal (step S41). The user terminal receives the divided table page data from the Web contents control system 3 and displays the data on the display device (step S43).

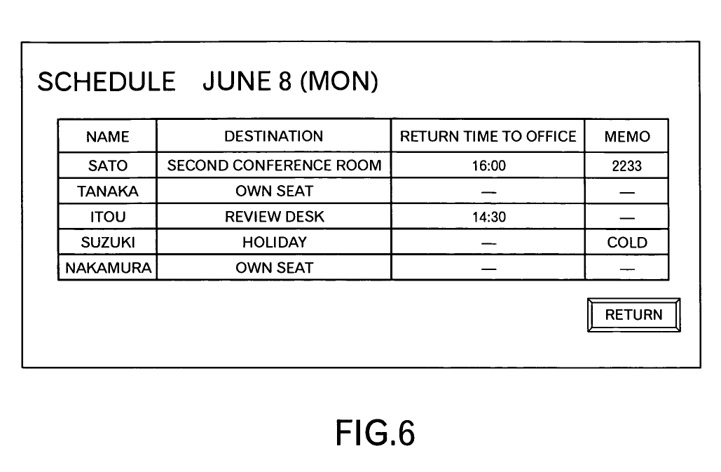

Here, there will be described such a case that a URL of an HTML file for making a table display as shown in FIG. 6 on a large-size screen such as a display screen of a personal computer or the like is accessed. In the table shown in FIG. 6, a name column, a destination column, a column of “return time to office” and a memo column are contained, and each record (line) of “sato”, “tanaka”, “itou”, “Suzuki”, and “nakamura” is contained.

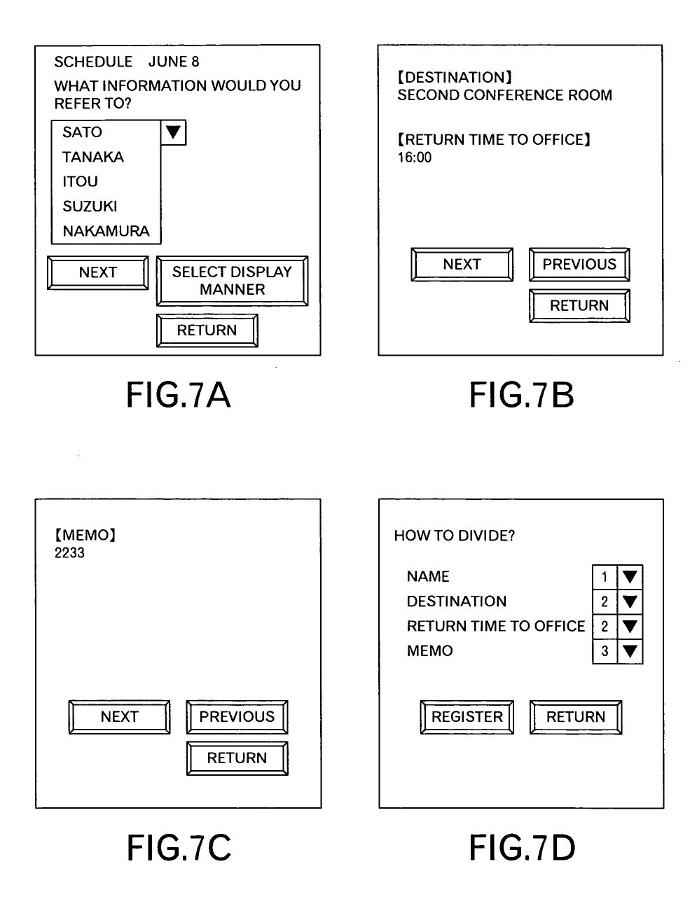

FIG. 7A shows an example of the divided table page for the first hierarchical layer generated at the step S37. FIG. 7A shows a case where the heading name for the first hierarchical layer is “name”. A message “which information would you refer to?” is added, and display elements “sato”, “tanaka”, “itou”, “Suzuki”, “nakamura” for the heading name “name” contained in the table are set as choices in the combo box. In addition, a “next” button to shift to the next hierarchical layer and a “select display manner” button to generate a table definition are also added. That is, the divided table page data contains data (a combo box, a group of radio buttons) for enabling selection of display elements relating to the heading for the first hierarchical layer, data (link, button or the like) for enabling an instruction of transition to the divided table page for the second hierarchical layer, and data (link, button or the like) for enabling an instruction of generating the table definition.

As described above, by making the user select the display elements relating to the headings for the first hierarchical layer, an effect is obtained in which the amount of data displayed in the second and subsequent hierarchical layers can be reduced and also the user can easily recognize the display contents.

Moreover, because the “select display manner” button for the transition to the page of generating the table definition is provided, the user can easily designate the hierarchical display configuration for a specific table.

The user looks at a display screen displayed on the display device of the user terminal as shown in FIG. 7A, and inputs data. The user terminal accepts an instruction input from the user, and transmits the instruction input data to the Web contents control system 3 (step S45). The access allocation processor 40 of the Web contents control system 3 receives the instruction input data from the user terminal (step S47), and judges on the basis of, for example, URL contained in the instruction input data whether an access to a specific page is instructed (step S49). In the example of FIG. 7A, it judges whether a “return” button is clicked. This is a case where an upper hierarchical layer page, which is just above the Web page shown in FIG. 6, is accessed, for example. In this case, the proxy access unit 33 is requested to access a specific page (in this example, the page at the just above-hierarchical layer). Therefore, the processing shifts to the step S13 of FIG. 2 via the terminal B.

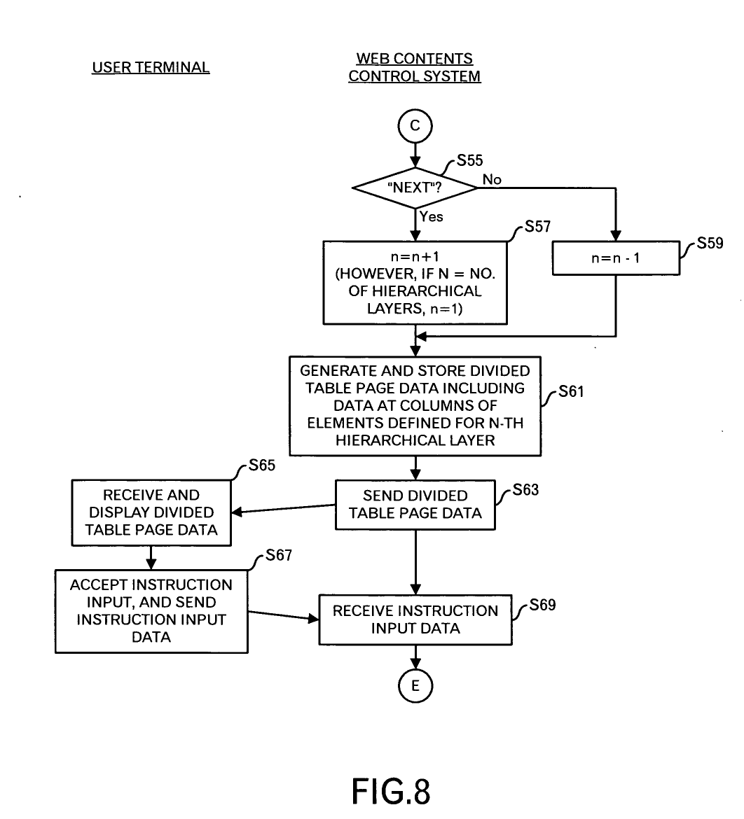

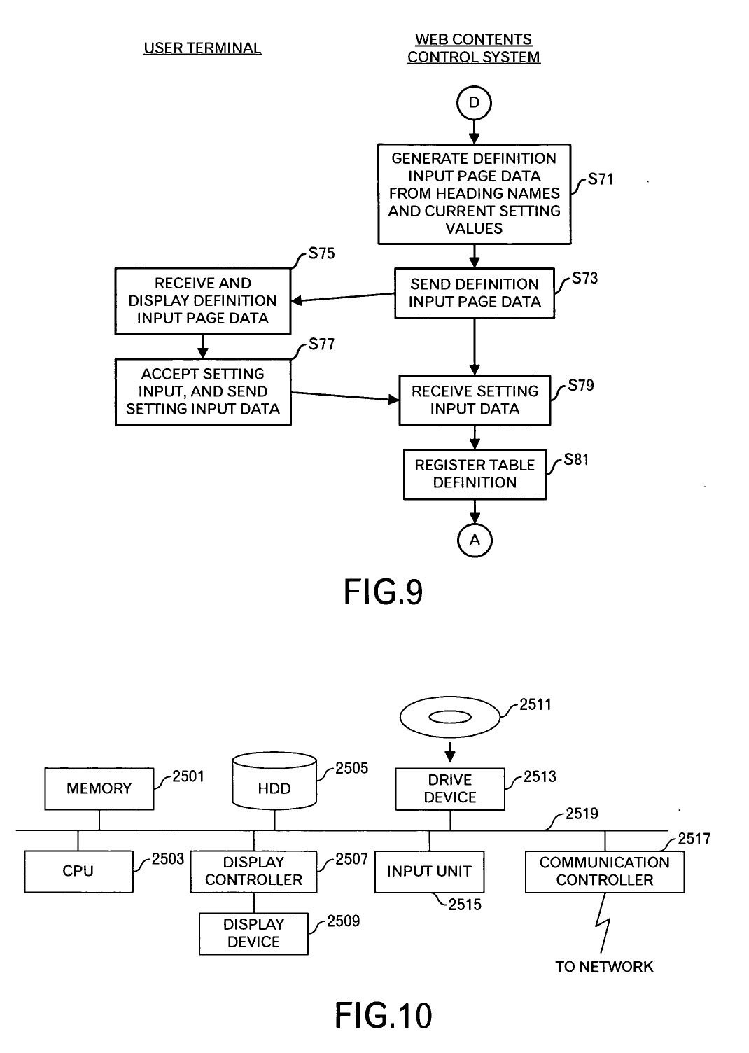

On the other hand, if it is judged that it is not the access instruction to the specific page, the access allocation processor 40 judges whether “select display manner”, that is, generation of the table definition is instructed or not (step S51). In the example of FIG. 7A, it judges whether the “select display manner” button is clicked or not. If the generation of the table definition corresponding to the table shown in FIG. 6 is instructed, the access allocation processor 40 requests the table definition setting processor 38 to carry out the processing, and the processing shifts to the processing flow of FIG. 9 through a terminal D. On the other hand, if it is judged that the “select display manner”, that is, the generation of the table definition is not instructed, it judges that shift to the next hierarchical layer or to the preceding hierarchical layer is instructed, and thus the processing shifts to the processing flow of FIG. 8 through a terminal C.

The processing flow subsequent to the terminal C will be described with reference to FIG. 8. The access allocation processor 40 requests the table reconfiguration processor 35 to carry out the table reconfiguration processing so that “shift to next hierarchical layer” or “shift to preceding hierarchical layer” is carried out. The table reconfiguration processor 35 judges on the basis of the received instruction input data or the like whether the instruction is “shift instruction to next hierarchical layer” or “shift instruction to preceding hierarchical layer” (step S55). If the instruction is judged as the “shift instruction to next hierarchical layer”, the table reconfiguration processor 35 first increments the counter n by 1 (step S57). However, it judges whether n is equal to the number of hierarchical layers before the increment. If it is judged that n is equal to the number of hierarchical layers, n is set to 1. On the other hand, if it is judged that the instruction is the “shift instruction to the preceding hierarchical layer”, the table reconfiguration processor 35 decrements the counter n by 1 (step S59). In the divided table page shown in FIG. 7A, which has only the “next” button, the “shift instruction to preceding layer” is not made.

Subsequently, the table reconfiguration processor 35 specifies the HTML file and the user ID on the basis of the received instruction input data and the session ID or the like to read out the corresponding table definition from the table definition data storage 36, and also reads out the data of the HTML file stored in the Web page data storage 34. Then, by using the read data, it generates divided table page data containing the data at columns of elements (heading columns) defined for the n-th hierarchical layer, and stores it in the divided table page data storage 37 (step S61). The transmitter 39 reads out the divided table page data stored in the divided table page data storage 37, and transmits the data concerned to the user terminal (step S63). The user terminal receives the divided table page data from the Web contents control system 3, and displays the data on the display device (step S65). In the case of n=2, a display screen as shown in FIG. 7B is displayed. FIG. 7B shows the display screen when the name “sato” is selected on the preceding page, and it contains display elements “second convention room” and “16:00” for the headings “destination” and “return time to office” which are contained in the record of the name “sato” and designated for the second hierarchical layer. Moreover, a “next” button for instructing shift to the next hierarchical layer and a “preceding” button for instructing shift to the preceding hierarchical layer are provided. Incidentally, as in the case of FIG. 7A, a “return” button for returning to the page at the hierarchical layer higher than the page of FIG. 6 is also provided.

The user looks at the display screen of the user terminal, and inputs some data. The user terminal accepts an instruction input from the user, and transmits the instruction input data to the Web contents control system 3 (step S67). The access allocation processor 40 of the Web contents control system 3 receives the instruction input data from the user terminal (step S69). The processing returns to the step S49 of FIG. 3 through a terminal E.

In a case where the “preceding” is clicked on the display screen shown in FIG. 7B, the display screen is shifted to the display screen shown in FIG. 7A. On the other hand, if the “next” is clicked, the display screen shown in FIG. 7C is displayed. In the example of FIG. 7C, n=3, and because the name “sato” is selected, it contains a display element “2233” for the heading name “memo” which is contained in the record of the name “sato” and designated for the third hierarchical layer. Moreover, a “next” button for instructing shift to the next hierarchical layer and a “preceding” button for instructing shift to the preceding hierarchical layer are provided. When the “next” button is clicked, the counter n is returned to 1 because n=the number of hierarchical layers (=3) in the step S57, and the display screen shown in FIG. 7A is displayed. Moreover, as in the case of FIG. 7A, a “return” button for returning to the page at the hierarchical layer higher than the page of FIG. 6 is provided.

Next, the processing subsequent to the terminal D will be described with reference to FIG. 9. The table definition setting processor 38 reads out the user instructing the generation of the table definition and the table definition corresponding to the HTML file to be processed from the table definition data storage 36 by using the instruction input data and the session ID, generates the definition input page data from the heading names and the current setting values (hierarchical structure) and then stores the data into the definition input page data storage 41 (step S71). Incidentally, there is a case where the user ID of the user instructing the generation of the table definition and the table definition corresponding to the HTML file to be processed do not exist. In this case, it reads out the HTML file stored in the Web page data storage 34, and generates the definition input page data from the data of the read HTML file. The transmitter 39 transmits to the user terminal, the definition input page data stored in the definition input page data storage 41 (step S73). The user terminal receives the definition input data from the Web contents control system 3, and displays the data on the display device (step S75) For example, a display screen as shown in FIG. 7D is displayed. In the example of FIG. 7D, a message of “how to divide?”, a list of heading names “name”, “destination”, “return time to office” and “memo”, a comb box for designating the hierarchical number corresponding to each heading name, a “register” button and a “return” button are provided. The initial values of the combo box are hierarchical numbers contained in the existing table definition corresponding to the user ID and the HTML file. If no existing definition exists, the hierarchical numbers are successively allocated to the headings from the left side in the table, for example.

The user looks at the display screen as shown in FIG. 7D to designate the hierarchical layer number for each heading, and clicks the “register” button. Incidentally, in a case where the user judges that no problem occurs in the table definition, which has already been registered, the user clicks the “return” button. Moreover, in this embodiment, only one heading can be designated for the first hierarchical layer, and plural headings can be designated for the subsequent hierarchical layers. The user terminal accepts the setting input (or the instruction for returning to the preceding display) from the user, and transmits the setting input data (or the instruction input data to return to the preceding display) to the Web contents control system 3 (step S77). The access allocation processor 40 of the Web contents control system 3 receives the setting input data (or the instruction input data to return to the preceding display) from the user terminal (step S79), and in the case of the setting input data, the access allocation processor 40 outputs the data to the table definition setting processor 38. The table definition setting processor 38 generates table definition from the received setting input data, and registers in the table definition data storage 36, the table definition corresponding to the user ID and the HTML file on the basis of the HTML file specified by the session ID or the like and the user ID (step S81). After the step S81 or when the instruction input data to return to the preceding display is received, the access allocation processor 40 requests the table reconfiguration processor 35 to carry out the processing. Then, the processing returns to the step S31 of FIG. 3 through the terminal A.

By carrying out the processing as described above, the user can designate the display style of a hierarchical structure, which is easily usable, for the table. Moreover, a necessary record can be narrowed down from the heading in the first hierarchical layer, and thus the display can be more easily viewable than a simple table dividing manner. Furthermore, the display screen can be shifted from the divided table page for the first hierarchical layer, which is displayed in response to an instruction of displaying a specific page containing a table, to the setting of the table definition, so that the table definition can be immediately reset to an easily viewable style, resulting in enhancement of usability.

The embodiment of the present invention has been described above, however, the present invention is not limited to the aforementioned embodiment. For example, the functional block diagram of FIG. 1 is an example, and each functional block does not necessarily correspond to an actual program module. Furthermore, the processing flow described above is an example, and thus any processing flow may be used insofar as the display screens shown in FIGS. 7A to 7D can be realized.

In addition, the Web contents control system 3 is a computer, and the computer has a configuration as shown in FIG. 10. That is, a memory 2501, a CPU 2503, a hard disk drive (HDD) 2505, a display controller 2507 connected to a display device 2509, a drive device 2513 for a removal disk 2511, an input device 2515, and a communication controller 2517 for connection with a network are connected through a bus 2519. An operating system (OS) and an application program for carrying out the foregoing processing stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operation. Besides, intermediate processing data is stored in the memory 2501, and if necessary, it is stored in the HDD 2505. In this embodiment of this invention, the application program to realize the aforementioned functions is stored in the removal disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application program are systematically cooperated with each other, so that various functions as described above in details are realized.

Furthermore, the cellular phone 5a and PDA 5b has a flash memory in place of the HDD 2505, the drive device 2513 and the like, and there is no large difference with the aforementioned configuration shown in FIG. 10.

Although the present invention has been described with respect to a specific preferred embodiment thereof, various change and modifications may be suggested to one skilled in the art, and it is intended that the present invention encompass such changes and modifications as fall within the scope of the appended claims.

1. A Hyper Text Markup Language (HTML) file processing method, comprising:
if an HTML file including a table definition is received from another server in response to a request from a terminal of a user, referring to a hierarchical display definition data storage for storing hierarchical display definition data of a table, which is preset by said user for a specific HTML file including a table definition, to specify a hierarchical display definition data for the received HTML file; and
extracting display elements to be displayed at a first hierarchical layer of the received HTML file according to the specified hierarchical display definition data to generate an HTML file for said first hierarchical layer, and transmitting said HTML file to said terminal of said user.

2. The HTML file processing method as set forth in claim 1, wherein said HTML file for said first hierarchical layer includes data for enabling an instruction of generating said hierarchical display definition data for the received HTML file.

3. The HTML file processing method as set forth in claim 1, wherein said HTML file for said first hierarchical layer includes data for enabling selection of any one of said display elements to be displayed at said first hierarchical layer.

4. The HTML file processing method as set forth in claim 2, further comprising:
if said instruction of generating said hierarchical display definition data is received from said terminal of said user, generating and transmitting to said terminal of said user, an HTML file including headings contained in said table and data for enabling to designate a display hierarchical layer for each of said headings, by referring to the received HTML file; and
if designation data of said display hierarchical layer of said heading is received from said terminal of said user, generating and storing into said hierarchical display definition data storage, hierarchical display definition data from said designation data.

5. The HTML file processing method as set forth in claim 3, further comprising:
if identification data of the selected display element is received from said terminal of said user, extracting from the received HTML file, data associated with a display element, which is specified by said identification data and is to be displayed at a second hierarchical layer defined in the specified hierarchical display definition data; and
generating and transmitting to said terminal of said user, an HTML file for said second hierarchical layer by using the extracted data.

6. The HTML file processing method as set forth in claim 1, wherein said referring comprises:
if hierarchical display definition data corresponding to the received HTML file cannot be specified when referring to said hierarchical display definition data storage, specifying default hierarchical display definition data as said hierarchical display definition data for the received HTML file.

7. The HTML file processing method as set forth in claim 1, wherein said hierarchical display definition data includes heading names in columns of said table and layer numbers.

8. A program embodied on a medium for causing a computer to carry out a Hyper Text Markup Language (HTML) file processing, said program comprising:
if an HTML file including a table definition is received from another server in response to a request from a terminal of a user, referring to a hierarchical display definition data storage for storing hierarchical display definition data of a table, which is preset by said user for a specific HTML file including a table definition, to specify a hierarchical display definition data for the received HTML file; and
extracting display elements to be displayed at a first hierarchical layer of the received HTML file according to the specified hierarchical display definition data to generate an HTML file for said first hierarchical layer, and transmitting said HTML file to said terminal of said user.

9. The program as set forth in claim 8, wherein said HTML file for said first hierarchical layer includes data for enabling an instruction of generating said hierarchical display definition data for the received HTML file.

10. The program as set forth in claim 8, wherein said HTML file for said first hierarchical layer includes data for enabling selection of any one of said display elements to be displayed at said first hierarchical layer.

11. The program as set forth in claim 9, further comprising:
if said instruction of generating said hierarchical display definition data is received from said terminal of said user, generating and transmitting to said terminal of said user, an HTML file including headings contained in said table and data for enabling to designate a display hierarchical layer for each of said headings, by referring to the received HTML file; and
if designation data of said display hierarchical layer of said heading is received from said terminal of said user, generating and storing into said hierarchical display definition data storage, hierarchical display definition data from said designation data.

12. The program as set forth in claim 10, further comprising:
if identification data of the selected display element is received from said terminal of said user, extracting from the received HTML file, data associated with a display element, which is specified by said identification data and is to be displayed at a second hierarchical layer defined in the specified hierarchical display definition data; and
generating and transmitting to said terminal of said user, an HTML file for said second hierarchical layer by using the extracted data.

13. The program as set forth in claim 8, wherein said referring comprises:
if hierarchical display definition data corresponding to the received HTML file cannot be specified when referring to said hierarchical display definition data storage, specifying default hierarchical display definition data as said hierarchical display definition data for the received HTML file.

14. The program as set forth in claim 8, wherein said hierarchical display definition data includes heading names in columns of said table and layer numbers.

15. A Hyper Text Markup Language (HTML) file processing apparatus, comprising:
a hierarchical display definition data specifying unit that refers to a hierarchical display definition data storage for storing hierarchical display definition data of a table, which is preset by a user for a specific HTML file including a table definition, to specify a hierarchical display definition data for a received HTML file, if an HTML file including a table definition is received from another server in response to a request from a terminal of said user; and
a unit that extracts display elements to be displayed at a first hierarchical layer of the received HTML file according to the specified hierarchical display definition data to generate an HTML file for said first hierarchical layer, and transmits said HTML file to said terminal of said user.

16. The HTML file processing apparatus as set forth in claim 15, wherein said HTML file for said first hierarchical layer includes data for enabling an instruction of generating said hierarchical display definition data for the received HTML file.

17. The HTML file processing apparatus as set forth in claim 15, wherein said HTML file for said first hierarchical layer includes data for enabling selection of any one of said display elements to be displayed at said first hierarchical layer.

18. The HTML file processing apparatus as set forth in claim 16, further comprising:
a unit that generates and transmits to said terminal of said user, an HTML file including headings contained in said table and data for enabling to designate a display hierarchical layer for each of said headings, by referring to the received HTML file, if said instruction of generating said hierarchical display definition data is received from said terminal of said user; and
a unit that generates and stores into said hierarchical display definition data storage, hierarchical display definition data from said designation data, if designation data of said display hierarchical layer of said heading is received from said terminal of said user.

19. The HTML file processing apparatus as set forth in claim 17, further comprising:
a unit that extracts from the received HTML file, if identification data of the selected display element is received from said terminal of said user, data associated with a display element, which is specified by said identification data and is to be displayed at a second hierarchical layer defined in the specified hierarchical display definition data; and
a unit that generates and transmits to said terminal of said user, an HTML file for said second hierarchical layer by using the extracted data.

20. The HTML file processing apparatus as set forth in claim 15, wherein said hierarchical display definition data specifying unit comprises:
a unit that specifies default hierarchical display definition data as said hierarchical display definition data for the received HTML file, if hierarchical display definition data corresponding to the received HTML file cannot be specified when referring to said hierarchical display definition data storage.

21. The HTML file processing apparatus as set forth in claim 15, wherein said hierarchical display definition data includes heading names in columns of said table and layer numbers.
